(19) United States
(12) Patent Application Publication
(10) Pub. No.: US 2026/0135733 A1
(43) Pub. Date: May 14, 2026

(54) METHOD AND APPARATUS OF CHANNEL ESTIMATING USING FREQUENCY SELECTIVITY IN WIRELESS COMMUNICATION SYSTEM

(71) Applicant: SAMSUNG ELECTRONICS CO., LTD., Suwon-si (KR)

(72) Inventors: Kwanghoon AN, Suwon-si (KR); Hyuntack LIM, Suwon-si (KR); Sangwon CHOI, Suwon-si (KR); Kyeongyeon KIM, Suwon-si (KR); Jaehong KWON, Suwon-si (KR)

(73) Assignee: SAMSUNG ELECTRONICS CO., LTD., Suwon-si (KR)

(21) Appl. No.: 19/389,960

(22) Filed: Nov. 14, 2025

Related U.S. Application Data
(63) Continuation of application No. PCT/KR2025/018706, filed on Nov. 13, 2025.

(30) Foreign Application Priority Data
Nov. 14, 2024 (KR) 10-2024-0162072

(51) Int. Cl. H04L 25/02; H04L 5/00

(52) U.S. Cl. CPC H04L 25/0204; H04L 5/006

(57) ABSTRACT

A method of estimating a channel by a reception apparatus in a wireless communication system, includes estimating a reception channel based on a received signal; determining a signal-to-noise ratio (SNR) of the received signal; estimating a frequency selectivity of the reception channel; determining a moving average filter based on the SNR and the frequency selectivity; and applying the determined moving average filter to the estimated reception channel.

### CROSS-REFERENCE TO RELATED APPLICATION(S)

This application is a continuation of an International Application No. PCT/KR2025/018706, filed on Nov. 13, 2025, which is based on and claims priority to Korean Patent Application No. 10-2024-0162072, filed on Nov. 14, 2024, in the Korean Intellectual Property Office, and the disclosures of which are incorporated by reference herein in their entireties.

### BACKGROUND

### 1. Field

The disclosure relates to a method and an apparatus for estimating a channel using frequency selectivity in a wireless communication system.

### 2. Description of Related Art

In orthogonal frequency division multiplexing (OFDM) communication systems such as long term evolution (LTE)/new radio (NR), data is delivered using time and frequency resources. For example, in the case of a physical uplink shared channel (PUSCH), when a base station drops scheduling information to a user equipment (UE), the UE transmits data to the allocated frequency and time domains, based on the information. At this time, the PUSCH may be allocated in units of multiple OFDM symbols in the time domain and in units of multiple resource blocks (RBs) in the frequency domain. One RB consists of 12 subcarriers, and each subcarrier is called a resource element (RE).

The base station should estimate a channel of a received signal to decode the data received from the UE, and in a general communication system, a pilot signal for channel estimation between a transmitter and a receiver is defined as a demodulation reference signal (DMRS) defined in the 3rd generation partnership project (3GPP) NR standard.

As for DMRS symbols, several symbols in the time domain may be allocated according to scheduling information, and subcarriers of multiple RBs allocated to the frequency domain are divided into DMRS REs and DATA REs. Six or four DMRS REs may be allocated to one RB according to a DMRS configuration type, and DMRSs may be allocated to the entire RB region when several layers are transmitted using a multiple input multiple output (MIMO) scheme. The receiver performs channel estimation by using DMRS REs in the received entire RB region.

A channel estimation method using DMRSs in the OFDM system representatively includes a least-square (LS) scheme and a minimum mean square error (MMSE) scheme. Although the MMSE scheme guarantees excellent performance, it is difficult to apply the MMSE scheme to real systems due to a high implementation complexity and high computational volume. Since the LS scheme has relatively low complexity compared to the MMSE scheme, is the LS scheme used in most systems. However, since deterioration occurs in terms of performance in the LS scheme, various methods of reducing the deterioration are being developed.

The above information may be presented as related art for the purpose of assisting in understanding the disclosure. None of the foregoing might be asserted as prior art relevant to the disclosure or used for determination on prior art.

### SUMMARY

The disclosure relates to an efficient channel estimation method and apparatus in a wireless communication system and provides a method and apparatus for adaptively selecting a frequency domain filter in consideration of frequency selectivity in a wireless communication channel experiencing multipath fading.

According to an aspect of the disclosure, a method of estimating a channel by a reception apparatus in a wireless communication system, includes: estimating a reception channel based on a received signal; determining a signal-to-noise ratio (SNR) of the received signal; estimating a frequency selectivity of the reception channel; determining a moving average filter based on the SNR and the frequency selectivity; and applying the determined moving average filter to the estimated reception channel.

According to an aspect of the disclosure, a reception apparatus for estimating a channel in a wireless communication system, includes: a transceiver; memory storing one or more instructions; and at least one processor operatively coupled to the memory and configured to execute the one or more instructions stored in the memory, in which the one or more instructions, when executed by the at least one processor individually or collectively, cause the reception apparatus to: estimate a reception channel based on a received signal; determine a signal-to-noise ratio (SNR) of the received signal; estimate a frequency selectivity of the reception channel; determine a moving average filter based on the SNR and the frequency selectivity; and apply the determined moving average filter to the estimated reception channel.

According to an aspect of the disclosure, a non-transitory computer-readable medium storing one or more instructions that, when executed by at least one processor of an electronic device in a wireless communication system, cause the electronic device to: estimate a reception channel based on a received signal, determine a signal-to-noise ratio (SNR) of the received signal, estimate a frequency selectivity of the reception channel, determine a moving average filter based on the SNR and the frequency selectivity, and apply the determined moving average filter to the estimated reception channel.

According to one or more embodiments of the disclosure, it may be possible to reduce complexity by estimating a channel variation in the frequency domain without any conversion of the received signal to the time domain, and improve the estimation performance regardless of the number of resource blocks.

Further, when a moving average filter is used in the frequency domain, it may be possible to improve the channel estimation performance since the size of the filter can be determined according to a frequency selectivity.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a flowchart illustrating an operation of a channel estimator of a reception device in a wireless communication system according to one or more embodiments;

FIGS. 2A and 2B are diagrams illustrating an example of a method of determining a frequency selectivity, based on conversion of a signal allocated in the frequency domain into a time domain signal through inverse discrete Fourier transform (IDFT) or inverse fast Fourier transform (IFFT) in the wireless communication system according to one or more embodiments;

FIG. 3 is a diagram illustrating an example of a configuration of a block diagram of a channel estimator of a reception device in a wireless communication system according to one or more embodiments of the disclosure;

FIG. 4 is a flowchart illustrating an example of an operation of the channel estimator of the reception device in the wireless communication system according to an embodiment of the disclosure;

FIG. 5 is a flowchart illustrating an example of an operation of determining the number of subcarriers to group channels of which a channel variation is estimated in a pre-processing operation for estimating a frequency channel characteristic according to an embodiment of the disclosure;

FIG. 6 is a diagram illustrating an example of a method of converting subcarriers into average channel values when it is determined that the number of subcarriers to group channels of which the channel variation is estimated in FIG. 5 is “3” according to an embodiment of the disclosure;

FIG. 7 is a flowchart illustrating an example of an operation of determining the frequency selectivity and selecting the size of a moving average filter according to an embodiment of the disclosure;

FIG. 8 is a diagram illustrating performance comparison through simulation of the probability of determining a TDL-A channel in the TDL-A channel according to a signal-to-noise ratio interval when the moving average filter is used according to an embodiment of the disclosure;

FIG. 9 is a diagram illustrating comparison of the channel estimation performance in a TDL-C channel when the moving average filter is used according to an embodiment of the disclosure;

FIG. 10 is a diagram illustrating comparison of the channel estimation performance in the TDL-A channel when the moving average filter is used according to an embodiment of the disclosure;

FIG. 11 is a diagram illustrating comparison of the channel estimation performance in the TDL-C channel when the moving average filter is used according to an embodiment of the disclosure;

FIG. 12 is a flowchart illustrating an example of the operation of the reception device according to an embodiment of the disclosure; and

FIG. 13 is a block diagram illustrating the structure of the reception device according to an embodiment of the disclosure.

### DETAILED DESCRIPTION

Hereinafter, the operation principle of the disclosure will be described in detail in conjunction with the accompanying drawings. In addition, a detailed description of known functions or configurations that may make the subject matter of the disclosure unclear will be omitted. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

As used herein, a base station (BS) refers to a network entity capable of allocating resources to terminals and communicating with the terminals through a wireless network, and may be at least one of an eNode B, a Node B, a gNB, a radio access network (RAN), an access network (AN), an RAN node, an integrated access/backhaul (IAB) node, a wireless access unit, a base station controller, a node on a network, or a transmission reception point (TRP). A user equipment (UE) may be at least one of a terminal, a mobile station (MS), a cellular phone, a smartphone, a computer, or a multimedia system capable of performing a communication function.

The disclosure describes embodiments using terms used in 3GPP, such as LTE or NR, but this is an example for explanation. Various embodiments of the disclosure may be modified and applied to fit the characteristics of each system in other communication systems, and the disclosure is described based on the 3GPP NR uplink standard.

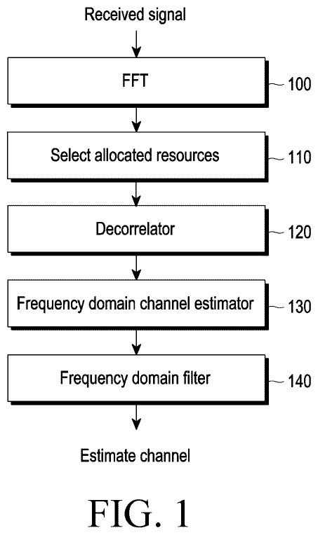

FIG. 1 is a flowchart illustrating an operation of a channel estimator of a reception device in a wireless communication system.

The channel estimator of the reception device in FIG. 1 may include at least one of a fast Fourier transform (FFT) 100, a resource selector 110, a decorrelator 120, a frequency domain channel estimator 130, and a frequency domain filter 140. The channel estimator of FIG. 1 may be included in a base station.

Referring to FIG. 1, a received pilot signal in FIG. 1 may be converted into a signal in the frequency domain through fast Fourier transform (FFT) operation by the FFT 100. The pilot signal may be referred as a reference signal (RS). The pilot signal may be used for supervisory, control, equalization, continuity, synchronization, or reference purposes.

Through the resource selector 110, the channel estimator of FIG. 1 may select a source element (RE) (e.g., a frequency tone) allocated to a specific electronic device (for example, UE) for the signal converted to the frequency domain.

The channel estimator may generate an input signal for channel estimation, based on a signal and a reference signal corresponding to at least one resource element (RE) allocated to the electronic device. As an embodiment, the channel estimator may generate an input signal for channel estimation through decorrelation for the signal corresponding to at least one resource element (RE) allocated to the electronic device through the decorrelator 120. In one or more examples, the decorrelator 120 may reduce autocorrelation within a signal or a cross-correlation within a set of signals.

As an embodiment, the decorrelator 120 of the channel estimator may generate the input signal for channel estimation by applying a complex conjugate of the reference signal to the signal corresponding to at least one resource region (RB) allocated to the electronic device. For example, the input signal for channel estimation may be generated by classifying the signal corresponding to at least one resource region (RB) allocated to the electronic device as the reference signal. As an embodiment, the reference signal may include a demodulation reference signal (DMRS). As an embodiment, the signal corresponding to at least one resource region (RB) allocated to the electronic device may include a reference signal sequence (e.g., a DMRS sequence) corresponding to a symbol (e.g., a DMRS symbol) including the reference signal among received signals provided from a communication circuit.

The frequency domain channel estimator 130 may estimate a channel by using the input signal for channel estimation. For example, the frequency domain channel estimator 130 may perform channel estimation by using the LS scheme. The frequency domain filter 140 may reduce a noise signal for the estimated channel value. As the frequency domain filter 140, for example, a moving average filter may be used. In one or more examples, a moving average filter may be a digital filter that calculates the average of a data set over a specific window of time or data points. The moving average filter may be used for smoothing data, reducing noise, and/or highlighting trends in time series data.

In the OFDM system, the base station estimates a channel of a received signal by using a DMRS within a PUSCH transmitted by the UE, and an example of an equation indicating the received signal in the frequency domain is as shown in [Equation 1] below.

$$Y ( k ) = H ( k ) X ( k ) + N ( k ) \qquad [ Equation 1 ]$$

H(k) denotes a reception channel of a k^{th} subcarrier, X(k) denotes a DMRS transmitted in the k^{th} subcarrier, and N(k) denotes a noise signal of the k^{th} subcarrier. H(k) may be calculated through channel estimation using the LS scheme for the transmitted reception signal Y(k), and an example of an equation indicating the same is as shown in [Equation 2] below.

$$H ( k ) = \frac{Y ( k )}{X ( k )} + \tilde{N} ( k ) \qquad [ Equation 2 ]$$

The noise signal Ñ(k) added to the reception channel H(k) may reduce the quality of the channel and deteriorate the channel estimation performance. The noise signal may be reduced using an appropriate filter in the frequency domain and, for example, a moving average filter may be used. An example of a signal passing through the moving average filter is as shown in [Equation 3] below.

$${H}^{M A} ( k ) = \frac{1}{{N}_{win}} {\sum }_{m = - {N}_{win} / 2}^{m = {N}_{win} / 2} H ( k + m ) \qquad [ Equation 3 ]$$

N_{win} denotes the size of the moving average filter, and may be determined according to a signal-to-noise ratio of the received signal since an appropriate value should be selected in consideration of an amount of the noise signal. [Equation 3] illustrates an example method of averaging channels of N_{win} subcarriers adjacent to the k^{th} subcarrier and may reduce the noise signal of each subcarrier.

However, in the communication system, a wireless channel has frequency selectivity in which a channel value in the frequency domain varies depending on multipath fading. Multipath fading means that a transmitted signal reaches the receiver through multiple paths, in which case the transmitted signal may have a different channel value and time delay. The longer the time delay, the larger the variation in the frequency domain channel, and the shorter the time delay, the smaller variation in the frequency domain channel. The large variation in the channel means that the channel is not constant, and the channel estimation performance may be further deteriorate if the moving average filter of the wrong size is used without considering the changing channel. Accordingly, in order to select the size N_{win} of the optimal moving average filter, embodiments of the present disclosure consider the signal-to-noise ratio of the received signal and the variation in the channel together.

To this end, in one or more examples, the time delay may be estimated by converting the signal in the frequency domain into the signal in the time domain. An example of an equation indicating conversion of the received signal in the frequency domain into the signal in the time domain through inverse fast Fourier transform (IFFT) or inverse discrete Fourier transform (IDFT) is as shown in [Equation 4] below.

$$y [ t ] = h [ t ] * x [ t ] + n [ t ] \qquad [ Equation 4 ]$$

In the above equation, the symbol * denotes a convolution operation, and a variation in the wireless channel is generated by multipath fading and an example of an equation thereof is as shown in [Equation 5] below.

$$y [ t ] = {\sum }_{i = 1}^{I} α [ i ] \cdot x [ t - {Δ}_{i} ] + n [ t ] \qquad [ Equation 5 ]$$

y[t] denotes a received signal for a t^{th} sample in the time domain, x[t] denotes a DMRS transmitted in the t^{th} sample, and n[t] denotes a noise signal of the t^{th} sample. α[i] denotes a channel value for an i^{th} path and Ai denotes a time delay value for the i^{th} path. When it is assumed that DMRSs received in each subcarrier. k in the frequency domain are all 1, DMRSs converted into signals in the frequency domain can be expressed by an impulse response as shown in [Equation 6] below.

$$y [ t ] = {\sum }_{i = 1}^{I} α [ i ] \cdot δ [ t - {Δ}_{i} ] + n [ t ] \qquad [ Equation 6 ]$$

The received signal converted into the signal in the time domain can be expressed in the shape in which the noise signal is added to the impulse response, in which case the channel value may exist in a sample having the time delay. The resolution capable of distinguishing the time delay value of the received signal may be proportional to the number of samples in the time domain, and the resolution of the time delay value may decrease as the number of RBs allocated in the frequency domain increases.

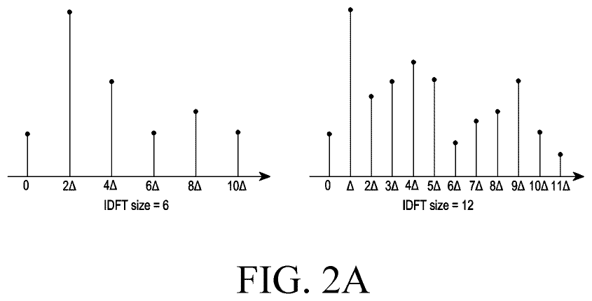

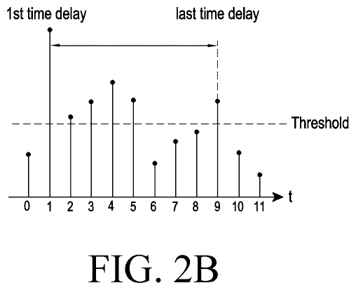

FIGS. 2A and 2B are diagrams illustrating an example of a method of determining a frequency selectivity, based on conversion of a signal allocated in the frequency domain into a time domain signal through inverse discrete Fourier transform (IDFT) or inverse fast Fourier transform (IFFT) in the wireless communication system.

FIG. 2A illustrates an example of conversion of 1RB (IDFT size=6) and 2 RBs (IDFT size=12) allocated in the frequency domain into the time domain signal. The resolution of the time delay in 2RBs is small compared to 1RB, which indicates that a more accurate time delay value may be estimated.

Referring to FIG. 2B, a specific threshold may be determined, samples equal to or lower than the threshold may be considered as the noise signal, and a sample having the longest time delay and a sample having the shortest time delay (e.g., 1st time delay) may be selected from samples larger than or equal to the threshold. The time delay value may be estimated by calculating the distance difference between the selected two samples, and the value may be used as a metric for determining the frequency selectivity.

The channel estimation performance may deteriorate if the frequency selectivity of the channel is not taken into account when the moving average filter is used in the frequency domain to reduce the noise signal in the wireless communication channel experiencing multipath fading.

As previously discussed, there is a method of estimating the time delay of the multipath fading channel by converting the frequency domain signal into the time domain signal, but when the frequency domain signal is converted into the time domain, a channel impulse response (CIR) leakage occurs, making it difficult to properly interpret it, and when RBs allocated to the frequency domain are small, the resolution of samples in the time domain increases, making it difficult to accurately estimate the time delay value. In addition, because complexity increases in the process of converting the signal in the frequency domain into time domain, performance degradation may occur in some communication systems using the moving average filter that does not take into account the channel frequency characteristics.

The embodiments of the present disclosure provide a method of solving problems of the related arts occurring in the time domain through estimation of the frequency selectivity of the received signal in the frequency domain in the wireless communication channel experiencing multipath fading and improving the channel estimation performance.

Specifically, a method of minimizing complexity in the channel of the received signal in the frequency domain and estimating a variation in the channel, a method of determining channel characteristics, and a method of selecting the size of the moving average filter suitable for the channel characteristics are provided.

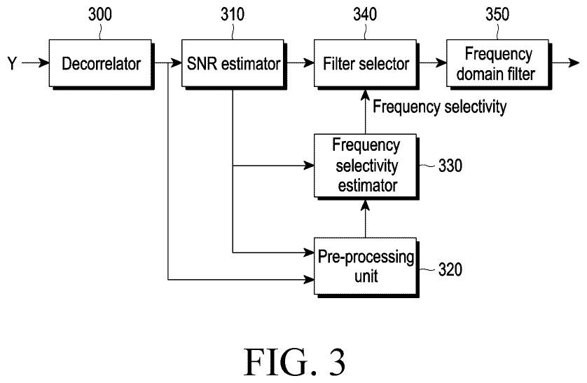

FIG. 3 is a diagram illustrating an example of a configuration of a block diagram of a channel estimator of a reception device in a wireless communication system according to an embodiment of the disclosure.

Referring to FIG. 3, the channel estimator may include at least one of a decorrelator 300, a signal-to-noise ratio (SNR) estimator 310, a pre-processing unit 320, a frequency selectivity estimator 330, a filter selector 340, and a frequency domain filter 350.

The channel estimator may generate an input signal for channel estimation through decorrelation for a signal corresponding to at least one resource element (RE) through decorrelator 300. The input signal for channel estimation may include a reference signal sequence (for example, a DMRS sequence) corresponding to a symbol (for example, a DMRS symbol) including a reference signal among received signals.

The decorrelator 300 may extract a channel in the frequency domain by removing the DMRS from the received signal and improve the channel estimation quality by using various schemes. In one or more examples, the DMRS may be a reference signal used in cellular communication systems to aid in channel estimation and demodulation of data signals. The SNR estimator 310 may estimate a signal-to-noise ratio of the received signal. The estimated signal-to-noise ratio and the reception channel may be transferred to the pre-processing unit 320, the frequency selectivity estimator 330, and the filter selector 340.

The pre-processing unit 320 may perform a pre-processing operation for estimating the frequency selectivity.

The frequency selectivity estimator 330 may estimate the frequency selectivity of the pre-processed channel (or estimated channel) received from the pre-processing unit 320. The frequency selectivity may calculate and estimate a variation in the reception channel and may be expressed by metric for determining a channel characteristic.

The filter selector 340 may select a moving average filter and the size of the filter by using the result of determining the frequency selectivity that is an output value of the frequency selectivity estimator 330 and a signal-to-noise ratio of the received signal that is an output value of the SNR estimator 310.

The frequency domain filter 350 may allow the filter selector 340 to pass the reception channel in the frequency domain through the selected filter, and the noise signal of the received signal may be reduced during the process.

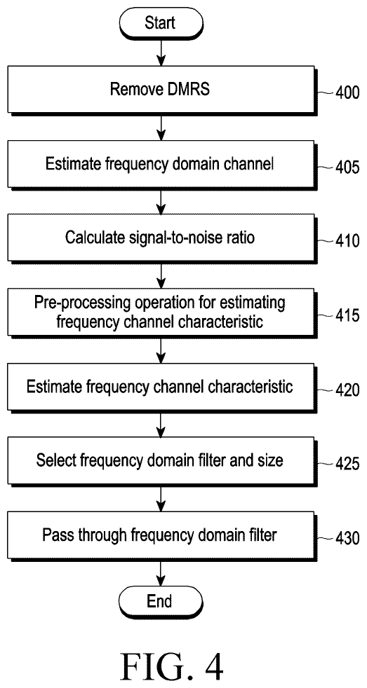

FIG. 4 is a flowchart illustrating an example of an operation of the channel estimator of the reception device in the wireless communication system according to an embodiment of the disclosure.

FIG. 4 illustrates the operation of the channel estimator of the reception device illustrated in FIG. 3. As an embodiment, FIG. 4 illustrates an operation of a channel estimator included in a base station in the OFDM system.

In operation 400, the channel estimator may convert the received signal into a frequency domain signal through FFT and remove a DMRS.

In the OFDM system, the base station may acquire an initial channel value by removing a DMRS within a PUSCH transmitted by the UE. Y_{r,p,l} denotes a received signal of a r^{th} antenna a p^{th} layer, and an l^{th} DMRS symbol, H_{r,p,l} denotes a reception channel value, and an example of an equation thereof is as shown in [Equation 7].

$${Y}_{r , p , l} ( k ) = {H}_{r , p , l} ( k ) {X}_{r , p , l} ( k ) + {N}_{r , p , l} ( k ) \qquad [ Equation 7 ]$$

H_{r,p,l} may be obtained using a DMRS X_{r,p,l} generated in a frequency domain channel estimation block and the received signal Y_{r,p,l}. An example of an equation thereof is as shown in [Equation 8] below.

$${H}_{r , p , l} ( k ) = {Y}_{r , p , l} ( k ) conj ( {X}_{r , p , l} ( k ) ) + {\tilde{N}}_{r , p , l} ( k ) \qquad [ Equation 8 ]$$

In operation 405, the channel estimator may perform frequency domain channel estimation. As an embodiment, the channel estimator may perform channel estimation by using the LS scheme. The channel estimator may use various methods in order to improve the quality of an initial channel value from which a DMRS has been removed.

In operation 410, the channel estimator may calculate a signal-to-noise ratio by calculating power H_POW_{r,p,l} of the reception channel and power N_POW_{r,p,l} of the noise signal, and an example of an equation thereof is as shown in [Equation 9] below.

$${N\_POW}_{r , p , l} = {\sum }_{k = 1}^{I} {\vert {\tilde{N}}_{r , p , l} ( k ) \vert}^{2} \qquad [ Equation 9 ]$$

$${H\_POW}_{r , p , l} = {\sum }_{k = 1}^{I} {\vert {H}_{r , p , l} ( k ) \vert}^{2}$$

When the number of subcarriers of the reception channel in the frequency domain is I, N_POW_{r,p,l} is power of the estimated noise signal in the I subcarriers, H_POW_{r,p,l} is total power of the channel, and an example of calculating the signal-to-noise ratio is as shown in [Equation 10] below.

$${SNR}_{r , p , l} = \frac{{H\_POW}_{r , p , l}}{{N\_POW}_{r , p , l}} \qquad [ Equation 10 ]$$

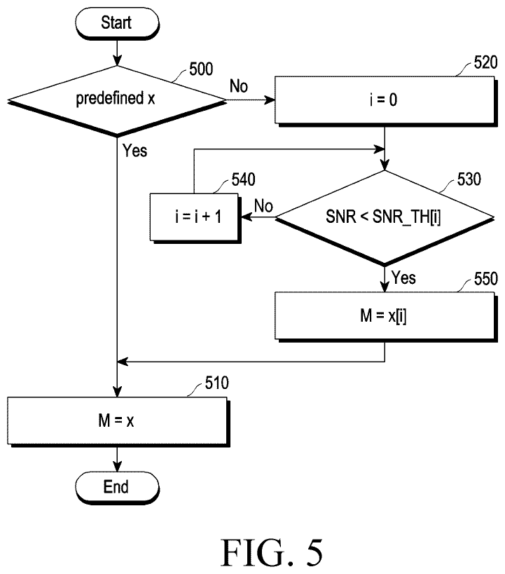

In operation 415, the channel estimator may perform a pre-processing operation for estimating the frequency selectivity. Performing the pre-processing operation is described below with reference to FIG. 5.

In operation 420, the channel estimator may estimate the frequency selectivity. That is, the channel estimator may estimate the selectivity of the frequency domain channel estimated in operation 405. As an embodiment, the frequency selectivity may be determined after a variation in the channel is calculated and converted into metric.

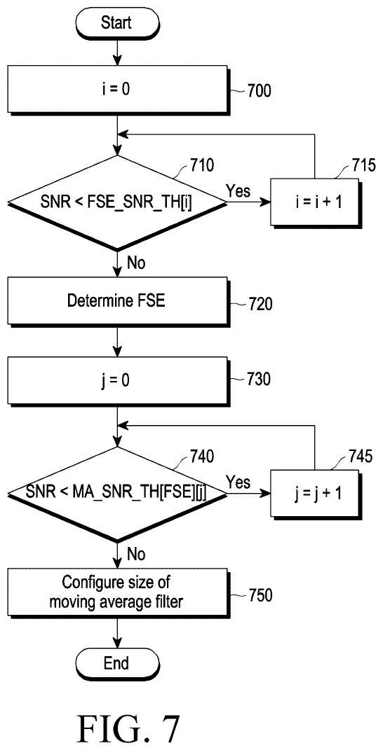

In operation 425, the channel estimator may select the frequency domain filter and the size. As an embodiment, the channel estimator may determine the frequency domain filter and the size in consideration of the signal-to-noise ratio of the received signal in operation 410 and the frequency selectivity estimated in operation 420. The size of the frequency domain filter may include N_{win} in [Equation 3]. A detailed operation is described below with reference to FIG. 7.

In operation 430, the reception channel may pass through the determined frequency domain filter so that a noise signal may be removed.

The variation in the channel for estimating the frequency selectivity may be calculated as a variation in a subcarrier in the frequency domain of the reception channel. When the quality of the reception channel is good, the channel characteristic may be more accurately determined using a variation in each subcarrier, but in the case of a channel having a low signal-to-noise ratio (when the quality of the reception channel is low), distortion of the noise signal may be larger than the variation in the channel.

In one or more examples, the channel quality may be determined using the signal-to-noise ratio received from the frequency domain channel estimator, and a reception channel having a signal-to-noise ratio equal to or lower than a predetermined threshold may perform a pre-processing operation to reduce the noise signal. As an embodiment, when it is determined that the quality of the received signal is good, the pre-processing operation may be omitted.

FIG. 5 is a flowchart illustrating an example of an operation of determining the number of subcarriers to group channels for estimating a channel variation in a pre-processing operation for estimating a frequency channel characteristic according to an embodiment of the disclosure.

FIG. 5 illustrates an operation in which the channel estimator selects the number M of subcarriers to be grouped in the pre-processing operation for estimating the frequency channel characteristic.

As an embodiment, an average channel value may be calculated by grouping frequency domain subcarriers into groups of M subcarriers through the pre-processing operation for reducing the noise signal. M may be flexibly selected according to the predetermined number of subcarriers, RB units, or the signal-to-noise ratio, and the number of average channel values for estimating frequency selectivity may be reduced to 1/M of the total number of subcarriers allocated in the frequency domain. In one or more examples, each group may include a same number of subcarriers. For example, if a total number of subcarriers is 10, and M is equal 2, then the 10 subcarriers are divided into 2 equal groups of 5 subcarriers. In one or more examples, at least one group from the groups of subcarriers may contain a different number of subcarriers.

Referring to FIG. 5, in operation 500, it may be determined whether there is a predefined value of x. When there is the predefined value of x, the channel estimator may determine the number M of subcarriers to be grouped as the value of x in operation 510.

However, when there is no predefined value of x, the channel estimator may correspond a value of “0” to variable i in operation 520. In operation 530, the channel estimator may determine whether the SNR is smaller than a threshold (SNR_TH[i]). When the SNR is not smaller than the threshold (SNR_TH[i]), the channel estimator may substitute i+1 into the variable I in operation 540.

When the SNR is smaller than the threshold (SNR_TH[i]), the channel estimator may determine that the number M of subcarriers to be grouped is a value of x[i] in operation 550.

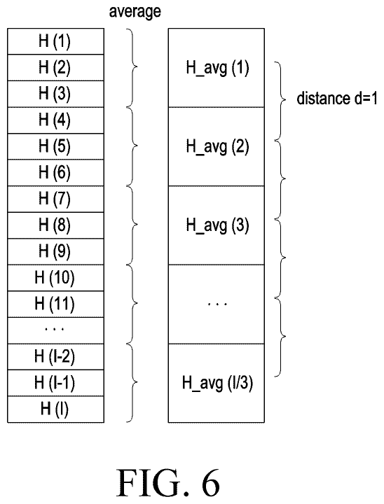

FIG. 6 is a diagram illustrating an example of a method of converting a channel value of subcarriers to an average channel value when the number of subcarriers to group channels to estimate the channel variation in FIG. 5 is determined as “3” according to an embodiment of the disclosure.

FIG. 6 illustrates a method of converting I subcarriers allocated in the frequency domain into average channel values H^{Avg} (H_avg) when the number M of subcarriers to be grouped is “3” and an example of the number of average channel values H^{Avg} to be used to calculate the frequency selectivity after conversion.

An example of an equation indicating a method of calculating an average channel value H_{r,p,l}^{Avg} in a reception channel of a r^{th} antenna, a p^{th} layer, and an l^{th} DMRS symbol is as shown in [Equation 11] below.

$${H}_{r , p , l}^{Avg} ( k ) = \frac{1}{M} {\sum }_{m = 1}^{M} {H}_{r , p , l} ( M * ( k - 1 ) + m ) \qquad [ Equation 11 ]$$

Referring to FIG. 6, when the number M of subcarriers to be grouped is determined as “3”, the subcarriers may be grouped into groups of 3 subcarriers and converted into average channel values: H_avg(1), T_avg(2), H_avg(3), . . . , H_avg(I/3) and the number of converted average channel values may be I/3.

As an embodiment, when channel values of the subcarriers are converted into average channel values, a moving average scheme used in the frequency domain filter may be used. For example, when the number M of subcarriers to be grouped is determined as “3”, H_avg(1) may be an average channel value of H(1), H(2), H(3), and H_avg(2) may be an average channel value of H(2), H(3), H(4). In this case, the number of average channel values for estimating the frequency selectivity is the same as the total number of subcarriers, and thus, an amount of calculations may relatively increase.

As an embodiment, the channel estimator may determine a distance d between two channels of which a channel variation is calculated to determine the frequency selectivity after the average channel values are derived. As illustrated in FIG. 6, when the distance d is 1, the channel variation between adjacent channel values (or average channel values) may be calculated. When the distance d is 2, a channel variation of channel values (or average channel values) separated by 2 may be calculated. For example, when the distance d for calculating the channel variation of the average channel values illustrated in FIG. 6 is 2, a method of determining the frequency selectivity by calculating the channel variation of the channel values separated by 2, such as H_avg(1) and H_avg(3) is described below with reference to FIG. 7.

The frequency selectivity estimator included in the channel estimator may calculate a variation of average channel values of subcarriers, convert the same into metric, and determine the frequency selectivity. The channel variation may be estimated in a form similar to an average time delay value by using a coefficient for the time delay obtained by differentiating each subcarrier of the reception channel, which can be replaced with calculation of the difference between subcarrier channel values in the frequency domain.

In order to calculate the time delay, the received signal may be differentiated several times, which may be expressed by calculating the difference in difference values between subcarrier channel values in the frequency domain. As this process is performed, the performance of determining the channel characteristic can be improved because the time delay value is reflected in the coefficient, but a high-band component included in the noise also increases, so the appropriate number of times should be selected. In the disclosure, as a method of estimating the frequency selectivity, a method of estimating the average variation by calculating a difference between subcarrier channel values, which are the primary differential forms of the reception channel is described.

The channel variation may be calculated as the difference between two adjacent average channels on the complex plane or two average channel values separated by the predetermined distance d. Specifically, an average variance D may be calculated by converting a ratio between an accumulated value of power of the difference between real, imaginary values of adjacent channels separated by d and an accumulated value of power of a real, imaginary value of the current channel into a normalized mean square error (NMSE).

As an embodiment, when a k^{th} average channel value obtained by grouping I subcarriers into groups of M subcarriers in the r^{th} antenna, the p^{th} layer, and the l^{th} DMRS symbol is

$${H}_{r , p , l}^{Avg} ( k ) ,$$

an example of an equation expressing the average variation of D_{r,p,l} two average channels separated by d is as shown in [Equation 12] below.

$${H\_rel}_{r , p , l} = {\sum }_{k = 1}^{( I / M ) - 1} {( {H}_{r , p , l}^{A v g} ( k ) \cdot r - {H}_{r , p , l}^{Avg} ( k + d ) \cdot r )}^{2} + {( {H}_{r , p , l}^{Avg} ( k ) \cdot i - {H}_{r , p , l}^{Avg} ( k + d ) \cdot i )}^{2} \qquad [ Equation 12 ]$$

$${H\_ref}_{r , p , l} = {\sum }_{k = 1}^{( I / M * d ) - 1} {( {H}_{r , p , l}^{Avg} ( k ) \cdot r )}^{2} + {( {H}_{r , p , l}^{Avg} ( k ) \cdot i )}^{2}$$

$${D}_{r , p , l} = \frac{{H\_rel}_{r , p , l}}{{H\_ref}_{r , p , l}}$$

In Equation 12, “.r” and “.i” indicate the real part and the imaginary part of a complex value, respectively.

H_ref_{r,p,l}(k) denotes power of a k^{th} average channel value, and H_rel_{r,p,l}(k) denotes power of the difference between the k^{th} average channel value and a (k+d)^{th} average channel value. The values may be accumulated and converted into the average variation D_{r,p,l}.

As an embodiment, the channel estimator may compare the average variation D_{r,p,l} with a threshold for determining the frequency selectivity and, when the channel average variation is larger than the threshold, may determine that the channel has a high frequency selectivity and that the other channels have a low frequency selectivity. As an embodiment, at least one of the estimated channel average variation D_{r,p,l} or the determined channel selectivity result may be reported to a higher layer. The channel selectivity result may include at least one of result information that determines a channel having high frequency selectivity or a channel having low frequency selectivity or information indicating whether the channel average variation is larger than the threshold. Here, the NMSE of the channel average variation is used and described, but other statistical characteristics such as MSE or variance of the channel average variation are also available.

As an embodiment, the channel estimator may optimize in advance the threshold for determining the frequency selectivity by using a channel defined in the communication standard such as 3GPP LTE or NR. For example, multiple channels having different delay profiles may be used, such as a TDL-A channel having small frequency selective fading (for example, small frequency selectivity) and a TDL-C channel having large frequency selective fading (for example, large frequency selectivity) defined in the 3GPP NR specification, and a threshold may be optimized based on the probability of properly determining the frequency selectivity in each channel.

As an embodiment, since the channel estimator cannot know the frequency selectivity of the real reception channel, the threshold should be configured in consideration of all probabilities of proper determination in each channel. For example, if a threshold is configured in consideration of only the probability of determining a TDL-A channel in a channel having a small frequency selectivity, such as a TDL-A channel, the frequency selectivity determination performance may deteriorate in a channel having a large frequency selectivity, such as a TDL-C channel.

Further, the noise signal existing in the reception channel may influence the size of the average channel variation. As an embodiment, because the larger the noise signal, the larger the channel variation is calculated, the signal-to-noise ratio may be divided into several stages and in consideration of the signal-to-noise ratio of the received signal, and a stepwise optimized threshold may be used.

The channel estimator may determine the moving average filter and the filter size by using the signal-to-noise ratio and the frequency selectivity. The moving average filter may be optimized in the same way as the threshold used to determine the frequency selectivity. As an embodiment, the size of the moving average filter that can have optimal performance according to multiple signal-to-noise ratios in channel models having different frequency selectivity such as a TDL-A channel and a TDL-C channel defined in the 3GPP NR specification may be determined, and managed and used in the form of a table.

Accordingly, the size of the frequency domain filter may be determined according to the signal-to noise ratio in a table of the moving average filter suitable for the frequency selectivity, and the reception channel may pass through the determined pass so as to remove the noise signal. An example of determining the frequency selectivity of the above channel estimator and selecting the size of the moving average filter is as shown in FIG. 7 below.

FIG. 7 is a diagram illustrating an example of an operation of determining the frequency selectivity and selecting the size of the moving average filter according to an embodiment of the disclosure.

Referring to FIG. 7, in operation 700, the channel estimator may substitute a value of “0” into variable i.

In operation 710, the channel estimator may determine whether the SNR is smaller than an SNR threshold (FSE_SNR_TH[i]) for estimation of the frequency selectivity. When the SNR is smaller than the SNR threshold (FSE_SNR_TH[i]) for estimation of the frequency selectivity, the channel estimator may substitute “i+1” into the variable i in operation 715.

When the SNR is not smaller than the SNR threshold (FSE_SNR_TH[i]) for estimation of the frequency selectivity, the channel estimator may determine frequency selectivity estimation (FSE) in operation 720.

In operation 730, the channel estimator may substitute a value of “0” into variable j.

In operation 740, the channel estimator may determine whether the SNR is smaller than an SNR threshold (MA_SNR_TH[FSE][i]) for determining the size of the moving average filter for the determined FSE.

When the SNR is smaller than MA_SNR_TH[FSE][i], the channel estimator may substitute “j+1” into the variable j in operation 745.

When the SNR is not smaller than MA_SNR_TH[FSE][i], the channel estimator may configure the size of the moving average filter in operation 750.

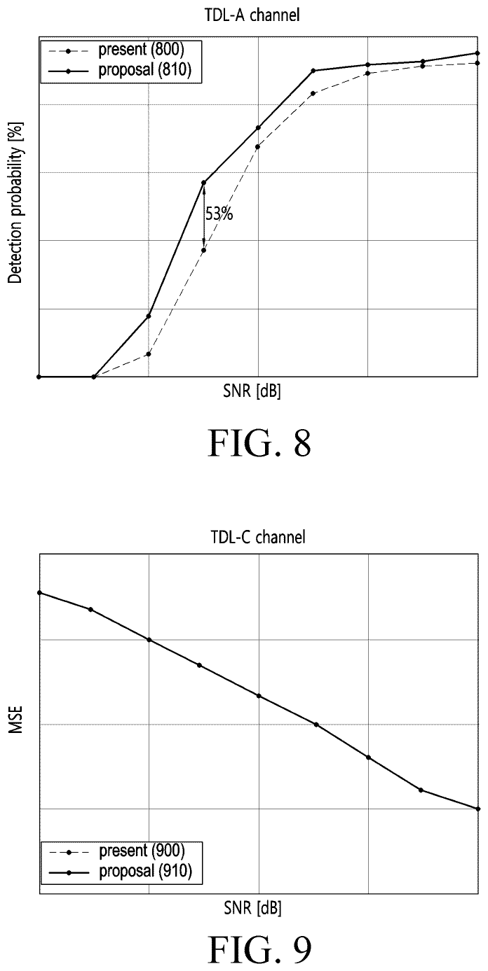

Hereinafter, FIGS. 8 to 11 illustrate the results of simulating the performance evaluation considering the 3GPP NR PUSCH transmission situation in order to confirm the effect of a scheme of adaptively applying the frequency domain filter, based on the frequency selectivity, according to the disclosure.

The moving average filter table and the threshold for determining the frequency selectivity were optimized using the TDL-A channel having the small frequency selectivity and the TDL-C channel having the large frequency selectivity defined in the 3GPP NR specification, and other delay profiles may also be optimized in several other channels.

FIG. 8 is a diagram illustrating performance comparison through the probability of determining a TDL-A channel in the TDL-A channel according to a signal-to-noise ratio interval when the moving average filter is used according to an embodiment of the disclosure.

FIG. 8 illustrates the simulation result of performance comparison between a scheme 800 of calculating a time delay value in the time domain and determining the frequency selectivity and a scheme 810 of adaptively applying the frequency domain filter proposed in the disclosure.

Referring to FIG. 8, in the simulation of the probability (detection probability) of determining the TDL-A channel in the TDL-A channel according to a signal-to-noise ratio interval, it can be seen that the probability in the scheme 810 of adaptively applying the frequency domain filter proposed in the disclosure is higher than the probability in the scheme 800 of calculating the time delay value in the time domain and determining the frequency selectivity. In particular, it can be seen that the detection performance is higher up to 50% or more in a weak electric field region where the signal-to-noise ratio is low.

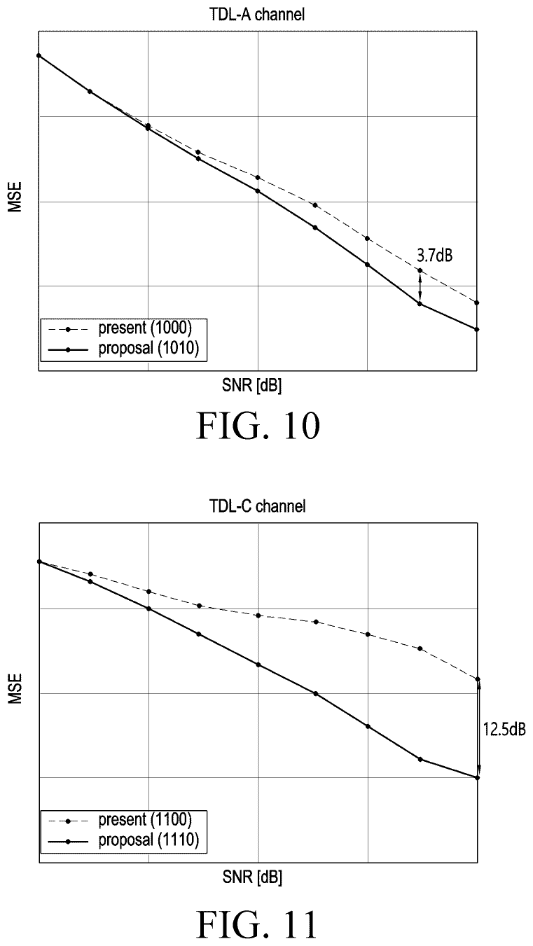

FIGS. 9 and 10 are diagrams illustrating comparison of the channel estimation performance in the TDL-C channel and the TDL-A channel when the moving average filter is used according to an embodiment of the disclosure.

FIGS. 9 and 10 illustrate the comparison result of the channel estimation performance of a scheme 900 of using a fixed moving average filter in the TDL-C and TDL-A channels and a scheme 910 of determining frequency selectivity and using a moving average filter suitable for a channel characteristic, and the moving average filter of the scheme 900 using the fixed moving average filter used the filter size optimized for the TDL-C channel.

Referring to FIG. 9, it can be seen that the scheme 910 of determining frequency selectivity in the TDL-C channel and using the moving average filter suitable for the TDL-C channel has the same performance as the scheme 900 using the fixed moving average filter optimized for the TDL-C channel.

FIG. 10 illustrates the result of comparison between a scheme 1010 of determining frequency selectivity in the TDL-A channel and using the moving average filter suitable for the TDL-C channel and a scheme 1000 using the fixed moving average filter optimized for the TDL-C channel.

Referring to FIG. 10, it can be seen that the scheme 1010 of determining the frequency selectivity and using the moving average filter suitable for the TDL-C channel determines the frequency selectivity and uses the moving average filter optimized for the TDL-A channel and thus has the MSE of the channel estimation result that is better up to 3 dB or more compared to the scheme 1000 using the fixed moving average filter optimized for the TDL-C channel.

FIG. 11 is a diagram illustrating comparison of the channel estimation performance in the TDL-C channel when the moving average filter is used according to an embodiment of the disclosure.

FIG. 11 illustrates the result of comparison between a scheme 1100 using the fixed moving average filter optimized for the TDL-A channel without consideration of the frequency selectivity and a scheme 1110 of determining the frequency selectivity and using the moving average filter suitable for the TDL-C channel.

Referring to FIG. 11, it can be seen that the scheme 1110 of determining the frequency selectivity and using the moving average filter suitable for the TDL-C channel determines the frequency selectivity and uses the moving average filter optimized for the TDL-C channel and thus has the MSE of the channel estimation result that is better up to 12 dB or more compared to the scheme 1100 using the fixed moving average filter optimized for the TDL-A channel.

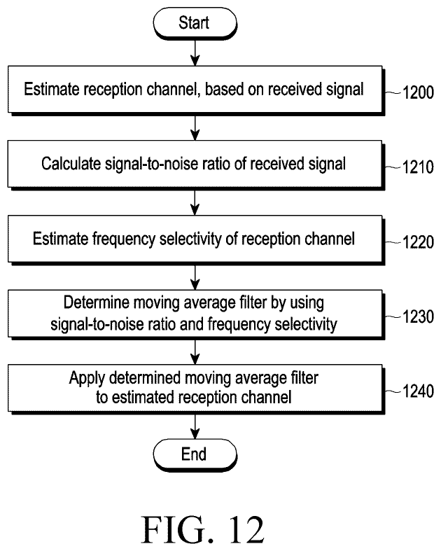

FIG. 12 is a flowchart illustrating an example of a channel estimation operation of the reception device according to an embodiment of the disclosure.

In operation 1200, the reception device may estimate a reception channel, based on a received signal.

In operation 1210, the reception device may determine a signal-to-noise ratio of the received signal.

In operation 1220, the reception device may estimate frequency selectivity of the reception channel.

In operation 1230, the reception device may determine a moving average filter by using the signal-to-noise ratio and the frequency selectivity.

In operation 1240, the reception device may apply the determined moving average filter to the estimated reception channel.

According to an aspect of the disclosure, a method of estimating a channel by a reception apparatus in a wireless communication system includes estimating a reception channel based on a received signal; determining a signal-to-noise ratio (SNR) of the received signal; estimating a frequency selectivity of the reception channel; determining a moving average filter based on the SNR and the frequency selectivity; and applying the determined moving average filter to the estimated reception channel.

The estimating the frequency selectivity of the reception channel further includes: determining a variation between channel values of subcarriers of the reception channel; and estimating the frequency selectivity of the reception channel based on the variation between the channel values.

The determining the variation between the channel values of the subcarriers of the reception channel further includes: determining channel average values for groups of the channel values of the subcarriers of the reception channel, determining a variation between the channel average values.

A number of the channel values of the subcarriers to be grouped is predefined or determined based on the SNR.

Based on determining that the SNR is larger than or equal to a threshold, the frequency selectivity is estimated based on the channel average values.

The variation between the channel values of the subcarriers of the reception channel is determined based on a distance between the channel values.

The information on the frequency selectivity of the reception channel comprises at least one of: variation information between channel values of the subcarriers of the reception channel, information indicating whether the reception channel is a channel having high frequency selectivity or a channel having lower frequency selectivity, or information indicating whether an average variation of the channel is larger than a threshold.

The variation between the channel values of the subcarriers of the reception channel is determined based on at least one of a normalized mean square error (NMSE), a mean square error (MSE), or a variance.

The determining the moving average filter comprises determining a size of the moving average filter.

The estimating the reception channel comprises estimating the reception channel by using a least-square (LS) scheme.

According to an aspect of the disclosure, a reception apparatus for estimating a channel in a wireless communication system, the reception apparatus including: a transceiver; a memory storing one or more instructions; and at least one processor operatively coupled to the memory and configured to execute the one or more instructions stored in the memory, in the one or more instructions, when executed by the at least one processor, cause the reception apparatus to: estimate a reception channel based on a received signal; determine a signal-to-noise ratio (SNR) of the received signal; estimate a frequency selectivity of the reception channel; determine a moving average filter based on the SNR and the frequency selectivity; and apply the determined moving average filter to the estimated reception channel.

The one or more instructions, when executed by the at least one processor, cause the reception apparatus to: determine a variation between channel values of subcarriers of the reception channel; and estimate the frequency selectivity of the reception channel, based on the variation between the channel values.

The one or more instructions, when executed by the at least one processor, cause the reception apparatus to: determine channel average values for groups of the channel values of the subcarriers of the reception channel, and calculate a variation between the channel average values.

A number of the channel values of the subcarriers to be grouped is predefined or determined based on the SNR.

Based on determining that the SNR is larger than or equal to a threshold, the frequency selectivity is estimated based on the channel average values.

The variation between the channel values of the subcarriers of the reception channel is determined based on a distance between the channel values.

Information on the frequency selectivity of the reception channel includes at least one of: variation information between channel values of the subcarriers of the reception channel, information indicating whether the reception channel is a channel having high frequency selectivity or a channel having lower frequency selectivity, or information indicating whether an average variation of the channel is larger than a threshold.

The variation between the channel values of the subcarriers of the reception channel is determined based on at least one of a normalized mean square error (NMSE), a mean square error (MSE), or a variance.

The one or more instructions, when executed by the at least one processor, cause the reception apparatus to determine a size of the moving average filter.

The one or more instructions, when executed by the at least one processor, cause the reception apparatus to estimate the reception channel by using a least-square (LS) scheme.

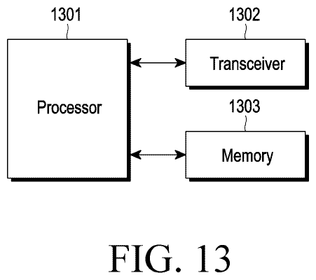

FIG. 13 is a block diagram illustrating the structure of the reception device according to an embodiment of the disclosure.

The reception device illustrated in FIG. 13 may include a base station that receives an uplink signal.

As illustrated in FIG. 13, the reception device of the disclosure may include a processor 1301, a transceiver 1302, and memory 1303. However, elements of the reception device are not limited to the above-described example. For example, the reception device may include more elements or fewer elements than the above-described elements. Further, the processor 1301, the transceiver 1302, and the memory 1303 may be implemented in the form of a single chip.

The processor 1301 may control a series of processes to allow the reception device to operate according to the embodiments of the disclosure. For example, elements of the reception device (for example, the channel estimator) may be controlled to perform channel estimation according to an embodiment of the disclosure. The processor 1301 may include at least one processor, and the processor 1301 may perform the method of the disclosure by executing a program stored in the memory 1303.

The transceiver 1302 may transmit and receive a signal to and from the UE. The signal transmitted and received to and from the UE may include control information and data. The transceiver 1302 may include an RF transmitter that up-converts and amplifies a frequency of a transmitted signal and an RF receiver that low-noise amplifies a received signal and down-converts a frequency. However, this is only an example of the transceiver 1302, and elements of the transceiver 1302 are not limited to the RF transmitter and the RF receiver. The transceiver 1302 may receive a signal through a wireless channel, output the signal to the processor 1301, and transmit the signal output from the processor 1301 through a wireless channel.

According to an embodiment, the memory 1303 may store a program and data required for the operation of the reception device. Further, the memory 1303 may store control information or data included in the signal transmitted and received by the reception device. The memory 1303 may be configured by storage media such as ROM, RAM, hard disc, CD-ROM, and DVD, or a combination of the storage media. The number of memories 1303 may be plural. According to an embodiment, the memory 1303 may store a program for performing the method corresponding to the embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A reception apparatus for estimating a channel in a wireless communication system, the reception apparatus comprising:
a transceiver;
memory storing one or more instructions; and
at least one processor operatively coupled to the memory and configured to execute the one or more instructions stored in the memory,
wherein the one or more instructions, when executed by the at least one processor individually or collectively, cause the reception apparatus to:
estimate a reception channel based on a received signal;
determine a signal-to-noise ratio (SNR) of the received signal;
estimate a frequency selectivity of the reception channel;
determine a moving average filter based on the SNR and the frequency selectivity; and
apply the determined moving average filter to the estimated reception channel.

2. The reception apparatus of claim 1, wherein the one or more instructions, when executed by the at least one processor individually or collectively, cause the reception apparatus to:
determine a variation between channel values of subcarriers of the reception channel; and
estimate the frequency selectivity of the reception channel, based on the variation between the channel values.

3. The reception apparatus of claim 2, wherein the one or more instructions, when executed by the at least one processor, cause the reception apparatus to:
determine channel average values for groups of the channel values of the subcarriers of the reception channel, and
determine a variation between the channel average values.

4. The reception apparatus of claim 2, wherein a number of the subcarriers of the channel values to be grouped is predefined or determined based on the SNR.

5. The reception apparatus of claim 3, wherein the one or more instructions, when executed by the at least one processor individually or collectively, cause the reception apparatus to, based on determining that the SNR is larger than or equal to a threshold, estimate the frequency selectivity based on the channel average values.

6. The reception apparatus of claim 2, wherein the variation between the channel values of the subcarriers of the reception channel is determined based on a distance between the channel values.

7. The reception apparatus of claim 1, wherein information on the frequency selectivity of the reception channel comprises at least one of:
variation information between channel values of the subcarriers of the reception channel,
information indicating whether the reception channel is a channel having high frequency selectivity or a channel having lower frequency selectivity, or
information indicating whether an average variation of the channel is larger than a threshold.

8. The reception apparatus of claim 2, wherein the variation between the channel values of the subcarriers of the reception channel is determined based on at least one of a normalized mean square error (NMSE), a mean square error (MSE), or a variance.

9. The reception apparatus of claim 1, wherein the one or more instructions, when executed by the at least one processor individually or collectively, cause the reception apparatus to determine a size of the moving average filter.

10. The reception apparatus of claim 1, wherein the one or more instructions, when executed by the at least one processor individually or collectively, cause the reception apparatus to estimate the reception channel by using a least-square (LS) scheme.

11. A method of estimating a channel by a reception apparatus in a wireless communication system, the method comprising:
estimating a reception channel based on a received signal;
determining a signal-to-noise ratio (SNR) of the received signal;
estimating a frequency selectivity of the reception channel;
determining a moving average filter based on the SNR and the frequency selectivity; and
applying the determined moving average filter to the estimated reception channel.

12. The method of claim 11, wherein estimating the frequency selectivity of the reception channel further comprises:
determining a variation between channel values of subcarriers of the reception channel; and
estimating the frequency selectivity of the reception channel based on the variation between the channel values.

13. The method of claim 12, wherein determining the variation between the channel values of the subcarriers of the reception channel further comprises:
determining channel average values for groups of the channel values of the subcarriers of the reception channel; and
determining a variation between the channel average values.

14. The method of claim 12, wherein a number of subcarriers of the channel values to be grouped is predefined or determined based on the SNR.

15. The method of claim 13, wherein, based on determining that the SNR is larger than or equal to a threshold, the frequency selectivity is estimated based on the channel average values.

16. The method of claim 12, wherein the variation between the channel values of the subcarriers of the reception channel is determined based on a distance between the channel values.

17. The method of claim 11, wherein information on the frequency selectivity of the reception channel comprises at least one of:
variation information between channel values of the subcarriers of the reception channel,
information indicating whether the reception channel is a channel having high frequency selectivity or a channel having lower frequency selectivity, or
information indicating whether an average variation of the channel is larger than a threshold.

18. The method of claim 12, wherein the variation between the channel values of the subcarriers of the reception channel is determined based on at least one of a normalized mean square error (NMSE), a mean square error (MSE), or a variance.

19. The method of claim 11, wherein determining the moving average filter comprises determining a size of the moving average filter.

20. A non-transitory computer-readable medium storing one or more instructions that, when executed by at least one processor of an electronic device in a wireless communication system, cause the electronic device to:
estimate a reception channel based on a received signal,
determine a signal-to-noise ratio (SNR) of the received signal,
estimate a frequency selectivity of the reception channel,
determine a moving average filter based on the SNR and the frequency selectivity, and
apply the determined moving average filter to the estimated reception channel.
